(19) United States
(12) Patent Application Publication
(10) Pub. No.: US 2005/0257649 A1
(43) Pub. Date: Nov. 24, 2005

(54) Ratchet wrench having switch structure

(76) Inventor: Shih-Kun Chen, Taichung Hsien (TW)

Correspondence Address: CHIN-CHING HSIEN, 235 CHUNG-HO BOX 8-24, TAIPEI HSIEN, TW

(21) Appl. No.: 10/851,959

(22) Filed: May 24, 2004

(51) Int. Cl. B25B 13/46

(52) U.S. Cl. 81/60

(57) ABSTRACT

A ratchet wrench having a switch structure that is stable to apply and easy to manufacture. It comprises a socket box, the ratchet receptacle and the switch receptacle formed within the box end of the handle of the wrench, respectively for housing a tool socket, a ratchet piece and a switch member. The switch structure thereby formed is used to restrict the rotational direction of a tool socket locked in the socket box. The switch member comprises an upright column, which is sandwiched between the bottom surface of the box end and a retaining plate, and a switch handle for driving the rotation of the upright column. The coupled motion of the switch handle and the upright column is stable and the parts are easy to make.

### FIELD OF THE INVENTION

The present invention relates to ratchet wrenches, and more particularly to a ratchet wrench having a switch structure wherein the switch member has separate parts that can provide a smooth motion upon switching the switch member. The switch member is easy to make, reducing the cost of producing ratchet wrenches.

### BACKGROUND OF THE INVENTION

Ratchet wrenches are for quickly fastening and loosening a screw bold or nut. They mainly comprise a handle with a box end and a tool socket having ratchet teeth. The central portion of the box end is provided with a socket box for housing a tool socket, and the tool socket is secured within the socket box using a buckle ring. A ratchet receptacle and a switch receptacle are formed in the portion connecting the handle and the box end, which are connected to the socket box. A switch member and a ratchet piece are respectively disposed within the ratchet receptacle and the switch receptacle. On side of the ratchet piece is provided with ratchet teeth that can be engaged with the ratchet teeth of the tool socket. The opposite side of the ratchet piece is provided with an inwardly arced edge for retaining the switch member. A hole for situating an elastic part and a holding piece is formed on the lateral face of the switch member facing the ratchet piece. The elastic part pushes the holding piece to support the ratchet piece. As the switch member is urged, the ratchet is driven to restrict the rotary direction of the tool socket, achieving the effect of changing tool socket direction.

The conventional ratchet wrenches described above is disadvantageous in that the switch member goes through the box end in a way that the restriction is in one rotary direction. As the switch member is moving, the holding mechanism will vibrate and undergo a unsteady motion, resulting in material fatigue after using for an extended time period.

To tackle these problems, an improved design utilizes a switch member having a projection extended from the lateral side facing the ratchet piece, for sharing the loading from the holding piece to the elastic part. This design is disadvantageous in that the stability of the switching motion is still there and the switch member with the projection is of irregular shape and therefore difficult to manufacture.

### SUMMARY OF THE INVENTION

Accordingly, the primary objective of the present invention is to provide a ratchet wrench having a switch structure wherein the central portion of a switch receptacle is provided with a through hole and the box end is provided with a stepped recess rim for embedding a retaining plate. A switch member comprises an upright column and a switch handle. The upper surface of the upright column is provided with a cylindrical bulged piece. The lateral wall of the upright column facing a ratchet piece is provided with a hole for situating an elastic member for supporting against a holding piece. The switch handle is pivotally connected to another end of the upright column through the through hole so that it is attached to the bottom surface of the box end. The retaining plate has a projected portion with a through retaining through hole so that the switch member is pivotally secured between the bottom surface of the box end and the retaining plate. Thereby, the switch member will not vibrate as it is switched.

The secondary objective of the present invention is to provide a ratchet wrench having a switch structure wherein the switch structure is simple and easy to produce.

The various objects and advantages of the present invention will be more readily understood from the following detailed description when read in conjunction with the appended drawings.

### BRIEF DESCRIPTION OF THE DRAWINGS

FIG. 1 is an exploded perspective view of a ratchet wrench having a switch structure according to the present invention.

FIG. 2 is a perspective view of the box end portion of the ratchet wrench having a switch structure.

FIG. 3 is a perspective view of the ratchet wrench having a switch structure.

FIG. 4 is a cross-sectional view of the ratchet wrench having a switch structure.

### DETAILED DESCRIPTION OF THE PREFERRED EMBODIMENTS

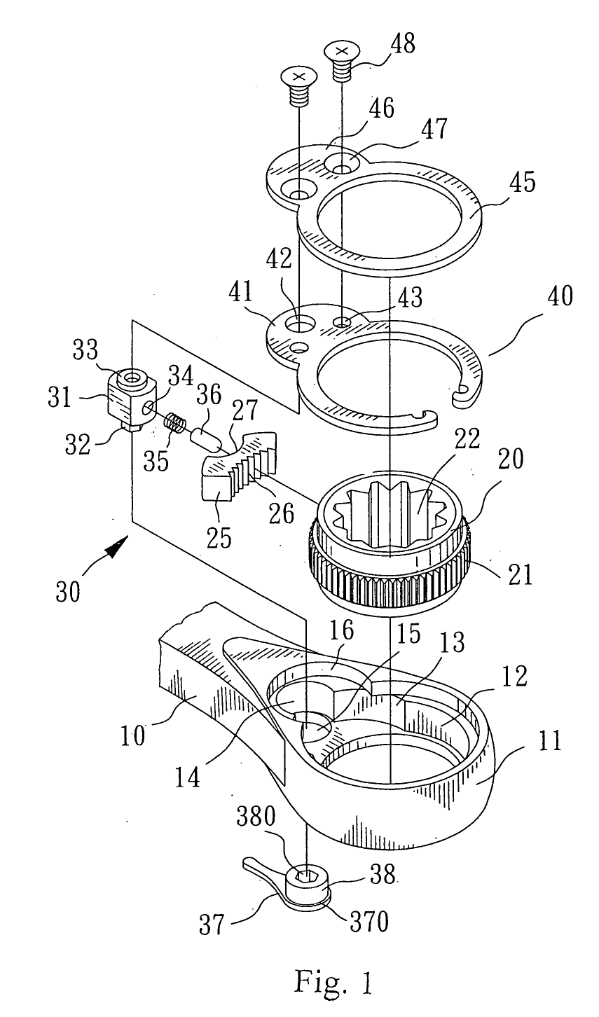

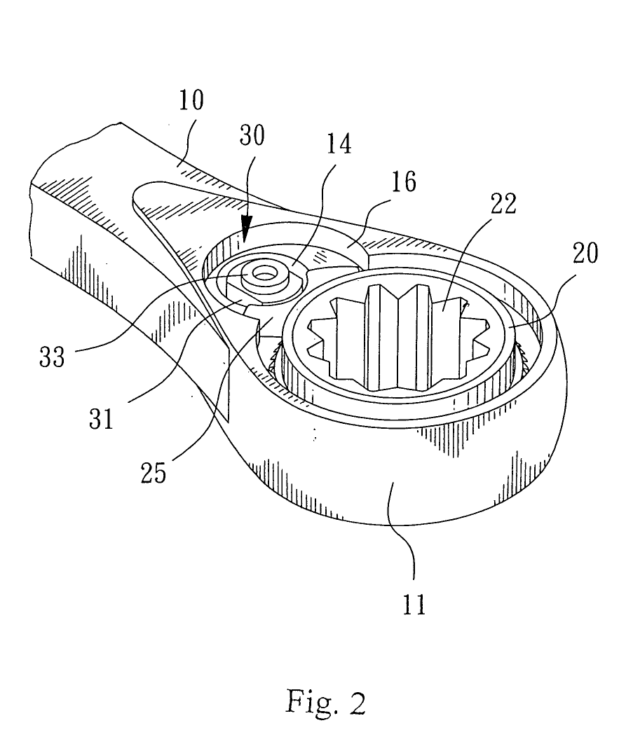

Referring to FIGS. 1, 2 and 3, a ratchet wrench having a switch structure according to the present invention comprises a handle 10, a box end 11 at one end of the handle 10, a socket box 12 formed substantially in a central portion of the box end 11 and a ratchet receptacle 13 connected to the socket box 12 on one side of the box end 11 of the handle 10. The box end 11 further comprises switch receptacle 14 connected to the ratchet receptacle 13. The socket box 12, the ratchet receptacle 13 and the switch receptacle 14 respectively house a tool socket 20, a ratchet piece 25 and a switch member 30 for the switch structure. The switch member 30 drives the ratchet piece 25 to set the rotational direction of the tool socket 20 or to idle the tool socket 20.

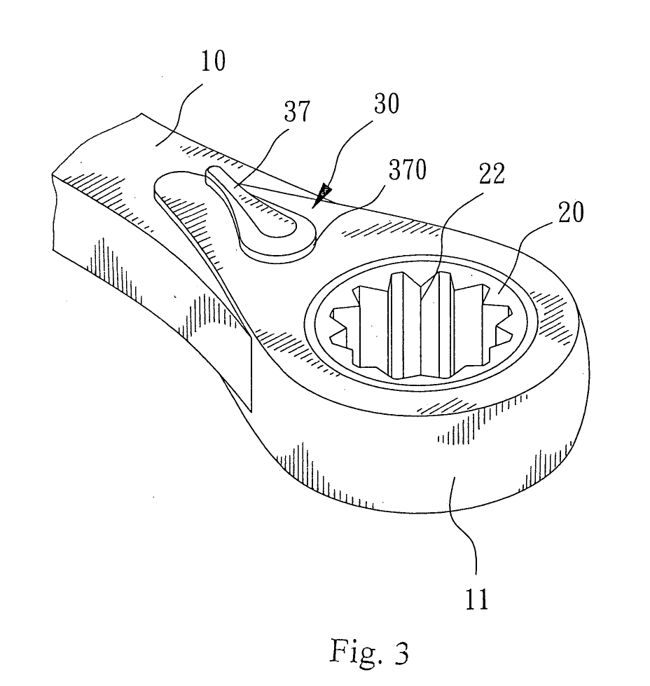

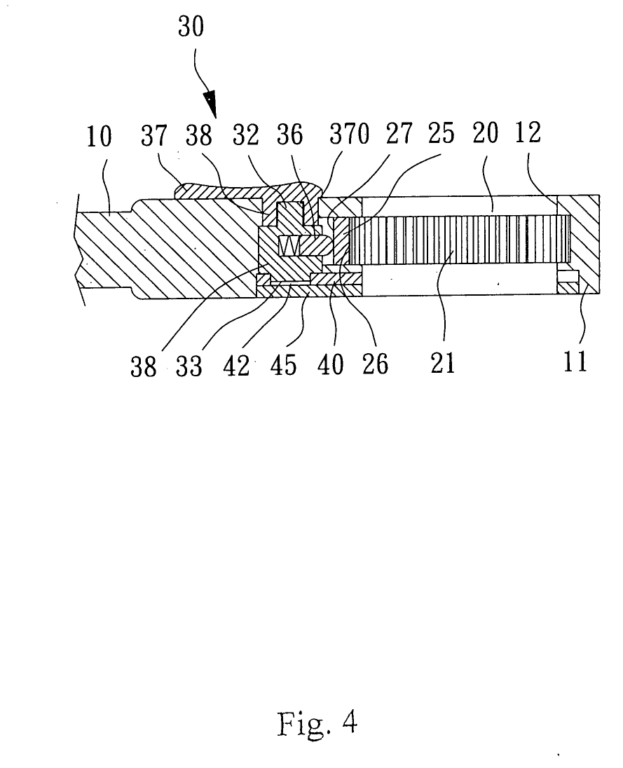

Referring to FIGS. 3 and 4, the bottom side of the central portion of the switch receptacle 14 of the box end 11 is provided with a through hole 15. The top surface of the box end 11 is further provided with a stepped recess rim 16 around those receptacles for embedding a ring-shaped retaining plate 40 and a cover plate 45 for preventing the invasion of dust. Further, the tool socket 20 can be of cylindrical or polygonal shape, and its outer rim is provided with a plurality of ratchet teeth 21. The central portion of the tool socket 20 is a polygonal hole 22 for locking screw bolt heads or nuts. The ratchet piece 25 in the ratchet receptacle 13 is provided with a plurality of ratchet teeth 26 for engaging with the tool socket 20. The side of the ratchet piece 25 facing the switch member 30 is provided with an arced edge 27 for retaining the switch member 30.

The switch member 30 comprises an upright column 31 and a switch handle 37. A polygonal bulged piece 32 and a cylindrical bulged piece 33 are respectively extended from the lower and the upper surface of the upright column 31. The lateral wall facing the ratchet piece 25 is provided with a hole 34 for situating a holding mechanism, which comprises an elastic member 35 and a holding member 36. The elastic part 35 supports against one end of the holding piece 36, whereas the other end of the holding piece 36 is engaged with the arced edge 27 of the ratchet piece 25. The switch handle 37 is provided with a cylindrical axial body 38 whose central hole 380 can be coupled with the upright column 31. Further, the portion of the switch handle 37 around the axial body 38 forms a rim lip 370 that is in contact with the bottom surface of the box end 11, thereby enhancing the stability of the rotation of the switch handle 37 about the axial body 38. The axial body 38 is pivotally connected to the through hole 15 of the box end 11. The axial body 38 is connected to the upright column 31 by engaging the bulged piece 32 and the central hole 380 to form a complete switch member 30.

The retaining plate 40 has a projected portion 41 for covering the switch member 30 within the switch receptacle 14. The projected portion 41 further includes a retaining hole 42 for pivotally retaining the bulged piece 33 of the switch member 30; therefore, the switch member 30 is pivotally secured between the box end 11 and the retaining plate 40. The projected portion 41 of the retaining plate 40 is further provided with a plurality of through holes 43.

The cover plate 45, disposed above the retaining plate 40, has a projected portion 46 on a lateral side corresponding to the projected portion 41 of the retaining plate 40, for providing a dust-proof effect. The projected portion 46 of the cover plate 45 is also provided with a plurality of through holes 47 corresponding to the through holes 43 of the retaining plate 40 so that screw bolts 48 can be used to lock the retaining plate 40 and the cover plate 45 on to the box end 11.

The aforesaid structure forms a switch structure for a ratchet wrench that is smooth to control and more durable than those of the prior art.

To use the present invention, the user firstly select a direction for applying the wrench by switch the switch handle 37 of the switch member 30, as shown in FIG. 4. The motion of the switch handle 37 urges the upright column 31 to rotate so that the holding piece 36 changes the direction of the ratchet piece 25. Since the rim lip 370 around the upright column 31 is attached on the bottom surface of the box end 11, and since the switch member 30 is sandwiched between the box end 11 and the retaining plate 40, the loading of the elastic member 35 and the holding member 36 is evenly distributed thereon. Therefore, the switching motion is smooth and the parts are not easy to get deformed, making the wrench much more durable.

Further, since the upright column 31 and the upright column 31 are separate parts, the manufacture of which will be easy, therefore reducing the production cost of the ratchet wrench having a switch structure.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A ratchet wrench having a switch structure, comprising:
a handle having an enlarged box end;
a socket box formed in said box end;
a ratchet receptacle formed in said box end next to said socket box;
a switch receptacle formed in said box end next to said socket box, said switch receptacle being provided with a through hole at the center of a bottom surface thereof, said switch receptacle being further provided with a stepped recess rim around said socket box, said ratchet receptacle and said switch receptacle for embedding a retaining plate;
a tool socket disposed in said socket box;
a ratchet piece in said ratchet receptacle; and
a switch member in said switch receptacle, said switch member including an upright column having a holding mechanism and a switch handle for driving said upright column, said upright column further including a bulged piece extend from a top face thereof for engaging said retaining plate, said holding mechanism being provided on a lateral face of said upright column facing said ratchet piece for driving said ratchet piece to achieve an effect of restricting the rotational direction of said tool socket, said switch handle being connected with said upright column on said bottom surface of said box end to form said switch member, said switch member thereby formed being pivotally mounted at said through hole of said switch receptacle, said switch member being cover a projected portion of said retaining plate, said bulged piece on said top face of said switch member being engaged with a retaining hole formed in said projected portion, whereby said switch member being pivotally mounted between said box end and said retaining plate;
whereby said ratchet wrench has a switch structure that is smooth to operate and durable.

2. The ratchet wrench having a switch structure of claim 1 wherein said switch member further includes a polygonal bulged piece extended from a bottom face thereof, and wherein said switch handle further includes a cylindrical axial body having a corresponding polygonal axial hole for securing said polygonal bulged piece.

3. The ratchet wrench having a switch structure of claim 1 wherein said switch handle is provided with a lip rim around said upright column thereof for stabilizing the rotary motion of said switch member as said switch handle is rotating about said upright column.

4. The ratchet wrench having a switch structure of claim 2 wherein said switch handle is provided with a lip rim around said upright column thereof for stabilizing the rotary motion of said switch member as said switch handle is rotating about said upright column.

5. The ratchet wrench having a switch structure of claim 1 wherein said projected portion of said retaining plate is provided with a plurality of through holes for locking said box end using a plurality of screw bolts.

6. The ratchet wrench having a switch structure of claim 5 wherein said stepped recess rim is further inserted with a cover plate above said retaining plate for preventing dust invasion into said switch structure, and wherein said cover plate further includes a corresponding projected portion having a plurality of through holes for locking with said retaining plate on said box end by using a plurality of screw bolts.

7. The ratchet wrench having a switch structure of claim 1 wherein said holding mechanism includes an elastic part housed in a hole on said lateral face of said upright column and a holding piece having a first end housed in said hole and a second end supporting against said ratchet piece.

8. The ratchet wrench having a switch structure of claim 1 wherein said ratchet piece is provided with ratchet teeth on a side engaging with said tool socket and an inwardly arced edge on a side facing said switch member for retaining said holding piece of said holding mechanism.
